(19) United States
(12) Patent Application Publication
(10) Pub. No.: US 2003/0228899 A1
(43) Pub. Date: Dec. 11, 2003

(54) Progressive jackpot system

(76) Inventor: Scott Evans, San Diego, CA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/161,997

(22) Filed: Jun. 5, 2002

(51) Int. Cl. A63F 13/00

(52) U.S. Cl. 463/25

(57) ABSTRACT

A method and system for playing a blackjack game in a plurality of rounds and incorporating a progressive jackpot into the blackjack game. A bonus bet separate from a bet made by the player is registered to allow participation in the progressive jackpot. The progressive jackpot is initiated in response to registering the bonus bet. A plurality of cards displayed in each of the rounds are compared to a predetermined card sequence for each of the rounds. A match is registered in each of the rounds in response to the plurality of cards matching the predetermined card sequence. Registration is preserved in the progressive jackpot between each of the rounds. At least a portion of the progressive jackpot is awarded to the player in response to registering a plurality of matches in the plurality of rounds.

### FIELD OF THE INVENTION

The present invention relates to a method of playing a game in a plurality of rounds and incorporating a progressive jackpot into the game. More specifically, the present invention relates to a method and a system for incorporating a progressive jackpot into a blackjack game.

### BACKGROUND OF THE INVENTION

Progressive jackpots are well known in the gaming industry for providing additional excitement to a player while playing a game. Typically, the progressive jackpot is awarded in addition to a normal payout from the game. In other words, the game continues normally and the progressive jackpot provides an additional award available to the player. In the prior art, the progressive jackpot is initiated by registering an ante or bonus bet for the progressive jackpot thereby registering the player for the progressive jackpot during play of the game. Registration in the progressive jackpot is terminated as each round of the game is terminated. In other words, the player does not remain registered in the progressive jackpot from round to round. Generally, the progressive jackpot is awarded to the player when the player reaches a predetermined event. Examples of predetermined events include a specific hand in poker such as a royal flush, coinciding reels in a slot machine such as three cherries in a line across three reels, and so on. Typically when the event is reached, the player is awarded the full value of the progressive jackpot. In some instances, a predetermined percentage of the progressive jackpot is awarded based on the predetermined event.

The majority of the prior art games incorporating the progressive jackpot are card games and slot machines, specifically, card games and slot machines in which a plurality of cards or symbols are dealt or displayed in each round of the game. The predetermined event required to win the progressive jackpot for card games is typically registering a match to a predetermined card sequence, i.e., the player's cards match a specific card order or total card value in a single round. A round is usually defined as the beginning and end of one full sequence, i.e., the end of the round brings the game to a satisfactory conclusion or completion. In blackjack, for example, a round begins when the player places an initial bet and ends with the dealer either collecting the initial bet and any subsequent mid-round bets, pushing the initial bet and any mid-round bets, paying the initial bet and any mid-round bets, or any combination thereof.

One example of a card game that can be played in a plurality of rounds and that incorporates a progressive jackpot into the game is shown in U.S. Pat. No. 6,346,044 to McCrea, Jr. (the '044 patent) issued on Feb. 12, 2002. The '044 patent teaches a progressive jackpot system for use in a blackjack game in which the predetermined percentage of the progressive jackpot awarded is based on the number of consecutive matches to a predetermined card sequence registered in a single round. For instance, ten percent of the jackpot is awarded if the player has two blackjacks in a single round and a greater percentage of the progressive jackpot is awarded if the player has three blackjacks in a single round. The '044 patent teaches automatically registering all players in the progressive jackpot in each round. As a result, the player cannot play the blackjack game without being registered in the progressive jackpot.

Although a certain level of excitement is encountered in playing the prior art games, there is a need in the art to develop a method of playing a game in which the player can preserve registration in the progressive jackpot between rounds and be awarded at least a portion of the progressive jackpot in response to matching a predetermined card sequence in two or more different rounds.

### BRIEF SUMMARY OF THE INVENTION

The present invention provides a method of playing a game in a plurality of rounds and incorporating a progressive jackpot into the game. A bet is registered prior to each of the rounds to begin play in each of the rounds. A bonus bet separate from the bet is registered to allow participation in the progressive jackpot. The progressive jackpot is initiated in response to registering the bonus bet. A plurality of cards is displayed in each of the rounds in response to registering the bet in each of the rounds. The plurality of cards is compared to a predetermined card sequence for each of the rounds. A match is registered in each of the rounds in response to the plurality of cards matching the predetermined card sequence for each of the rounds. Registration is preserved in the progressive jackpot between each of the rounds. At least a portion of the progressive jackpot is awarded in response to registering a plurality of matches in the plurality of rounds.

A progressive jackpot system is also provided. The system includes a jackpot register for registering the bonus bet and initiating the progressive jackpot in response to the bonus bet being wagered by the player. A jackpot processor is responsive to the jackpot register to control the progressive jackpot. A match register is in operative communication with the jackpot processor to register matches of the player when the plurality of cards matches the predetermined card sequence in each of the plurality of rounds. A counter is operative between rounds and responsive to the match register to count matches of the player registered by the match register.

The present invention provides several advantages over the prior art. For example, the player remains registered in the progressive jackpot from round to round and is awarded at least a portion of the progressive jackpot when two or more matches are registered in different rounds. This creates additional incentive and excitement for the players to continue play. In addition, the option or choice to register the bonus bet to initiate the progressive jackpot allows the player more control of the game.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a schematic representation of a progressive jackpot system of the present invention illustrating the connectivity of two units;

FIG. 2 is a flowchart illustrating steps of a game performed to determine when matches are registered in one embodiment of the present invention;

FIG. 3 is a flowchart illustrating steps of the game performed to determine when matches are registered in another embodiment of the present invention;

FIG. 4 is a flowchart illustrating steps of a blackjack game performed to determine whether a match is registered when a dealer initially shows an ace in a dealer's hand in accordance with the present invention; and

FIG. 5 is a schematic representation of a progressive jackpot system of an alternative embodiment of the present invention illustrating the connectivity of two units.

### DETAILED DESCRIPTION OF THE INVENTION

Referring to the Figures, wherein like numerals indicate like or corresponding steps or parts throughout the several views, a method of playing a game in a plurality of rounds and incorporating a progressive jackpot into the game will be hereinafter described.

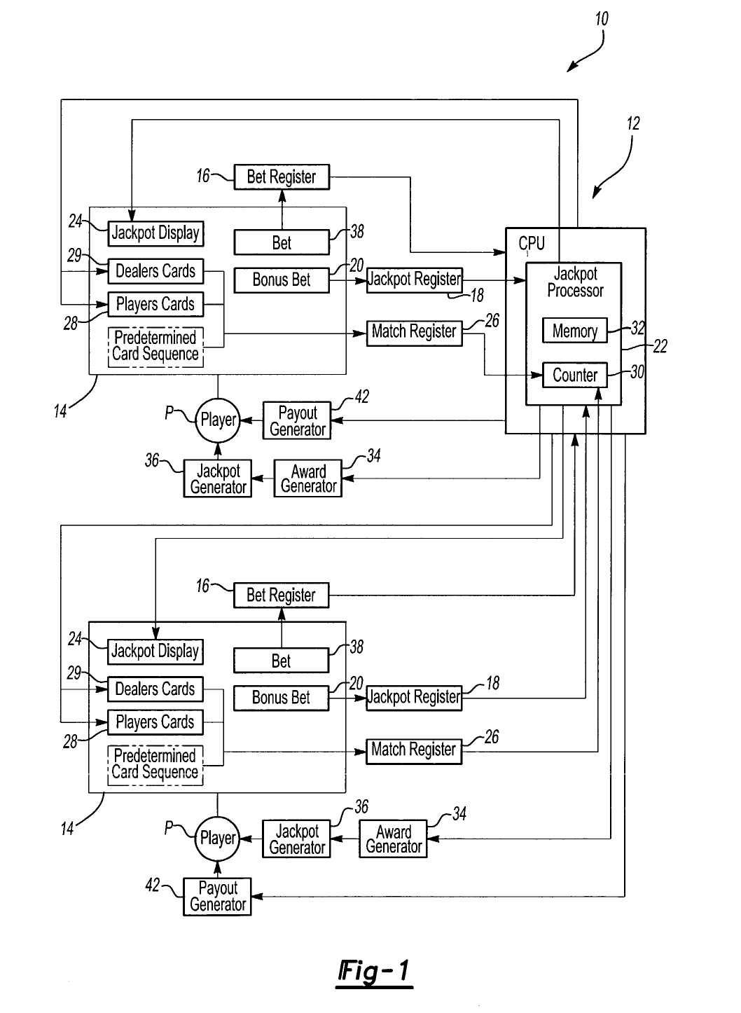

The method and a progressive jackpot system 10 to carry out the method are illustrated in FIGS. 1-5. The preferred embodiment of the present invention is a method of playing a computer blackjack game in an online, Internet environment that incorporates the progressive jackpot into the blackjack game. It is to be understood, however, that the game is not to be limited to the blackjack game and could alternatively be other games incorporating the progressive jackpot. For instance, the game could be a poker game, a baccarat game, and the like. However, for illustrative purposes, the game shall be hereinafter referred to as the blackjack game. More importantly, the present invention is not limited to the blackjack game being played in the online, Internet environment. Alternative embodiments of the present invention further include a video gaming format, similar in most respects to the online, computer blackjack game, and a live-card game. Each of these embodiments will be described in turn. It should be appreciated that the present invention is not to be limited to these embodiments.

The preferred embodiment is the method of playing the computer blackjack game in the online, Internet environment that utilizes the progressive jackpot system 10 to incorporate the progressive jackpot into the blackjack game. A brief description of a control system 12 for controlling play of the blackjack game and the progressive jackpot system 10 for controlling the progressive jackpot will be set forth prior to discussing the method of playing the computer blackjack game.

Referring to FIG. 1, the control system 12 is a central processing unit (CPU) that is in operative communication with a user interface, such as a computer screen 14, to control the play of the computer blackjack game. The CPU is in operative communication with a bet register 16 that registers bets wagered by a player P. The control system 12 offers the bet to the player P by way of bet indicia 38. The bet indicia 38 can be in the form of buttons on the computer screen 14 in the computer embodiment, or buttons on a video gaming terminal and markers or symbols on a table in other embodiments, as will be described further below. The player P activates the bet indicia 38 in the computer embodiment to wager the bet, by actuating the button on the screen 14 using a peripheral device. In response, the CPU displays or deals a plurality of cards to the player P and a dealer (not shown in FIG. 1).

The progressive jackpot system 10 is in operative communication with the control system 12 to control the progressive jackpot based on the play of the blackjack game. The progressive jackpot system 10 includes a jackpot register 18 to register a bonus bet and to initiate the progressive jackpot in response to the bonus bet being wagered by the player P. Bonus bet indicia 20 offers the bonus bet to the player P in the same manner that the bet indicia 38 offers the bet to the player P. The bonus bet indicia 20 is sensed by the jackpot register 18. A jackpot processor 22 responsive to the jackpot register 18 initiates the progressive jackpot. In other words, after the player P has wagered the bonus bet, the jackpot register 18 registers the bonus bet thereby acknowledging that the bonus bet has been wagered. The jackpot register 18 then sends a corresponding signal to the jackpot processor 22. In turn, the jackpot processor 22 registers the player P with the progressive jackpot. A jackpot display 24 is in operative communication with the jackpot processor 22 and continuously updates and displays a jackpot value of the progressive jackpot.

A match register 26 is in operative communication with the jackpot processor 22. The match register 26 registers matches of the player P when the plurality of cards dealt to the player P matches a predetermined card sequence (PCS) in each of a plurality of rounds. A portion of the progressive jackpot is awarded to the player P in response to registering a plurality of matches as will described further below. A player's cards presentation area 28 and a dealer's cards presentation area 29 is sensed by the match register 26. The cards presentation areas 28,29 display the plurality of cards dealt in each of the plurality of rounds.

A counter 30 is operative between rounds and responsive to the match register 26. The counter 30 counts matches of the player P registered by the match register 26. The greater the number of the matches counted, the greater the amount awarded to the player P. A memory 32 is operative between the rounds and determines when the progressive jackpot is terminated for the player P. The memory 32 is in operative communication with the jackpot processor 22 and the counter 30 to determine if the player P is registered in the progressive jackpot and to reset the counter 30 to zero when the progressive jackpot is terminated for the player P. An award generator 34 awards at least a portion of the progressive jackpot to the player P in response to the counter 30 recording the plurality of matches. A jackpot generator 36 is responsive to the award generator 34. The jackpot generator 36 pays the portion of the progressive jackpot awarded to the player P.

As shown in FIG. 1, two identical units, unit A and unit B are connected to the CPU and the jackpot processor 22. Unit A and unit B represent two players P at two different computers playing the blackjack game controlled by a common CPU. The CPU controls the play of the blackjack game for both unit A and unit B while the jackpot processor 22 controls the progressive jackpot for unit A and unit B. This connectivity is used below to illustrate the progressive nature of the present invention. It is to be appreciated that several players P can be connected to the CPU and the jackpot processor 22 to play for the same progressive jackpot.

It should be appreciated that the jackpot register 18, jackpot processor 22, match register 26, counter 30, award generator 34, and jackpot generator 36 could all be separate components as described above, or alternatively, they could be part of the jackpot processor 22 such that the CPU and the jackpot processor 22 are the primary components. In this instance, the CPU would control play of the blackjack game and the jackpot processor 22 would control the progressive jackpot based on the play of the blackjack game. In this manner, the components described above represent code to carry out their associated functions described. For instance, as previously described, the jackpot register 18 registers the bonus bet wagered by the player P. If the jackpot register 18 is part of the jackpot processor 22, then the jackpot register 18 is the code within the jackpot processor 22 that has adapted the jackpot processor 22 to register the bonus bet wagered by the player P, i.e., the function is still performed.

The jackpot processor 22 could also be part of the CPU such that the CPU is the primary component and controls both the play of the blackjack game and the progressive jackpot. In any case, it is to be understood that the bet register 16, jackpot register 18, jackpot processor 22, match register 26, counter 30, award generator 34, and so on are used to describe components or computer code for carrying out functions of the blackjack game and the progressive jackpot. It is not intended to limit the present invention by describing these components as separate components as is presented below.

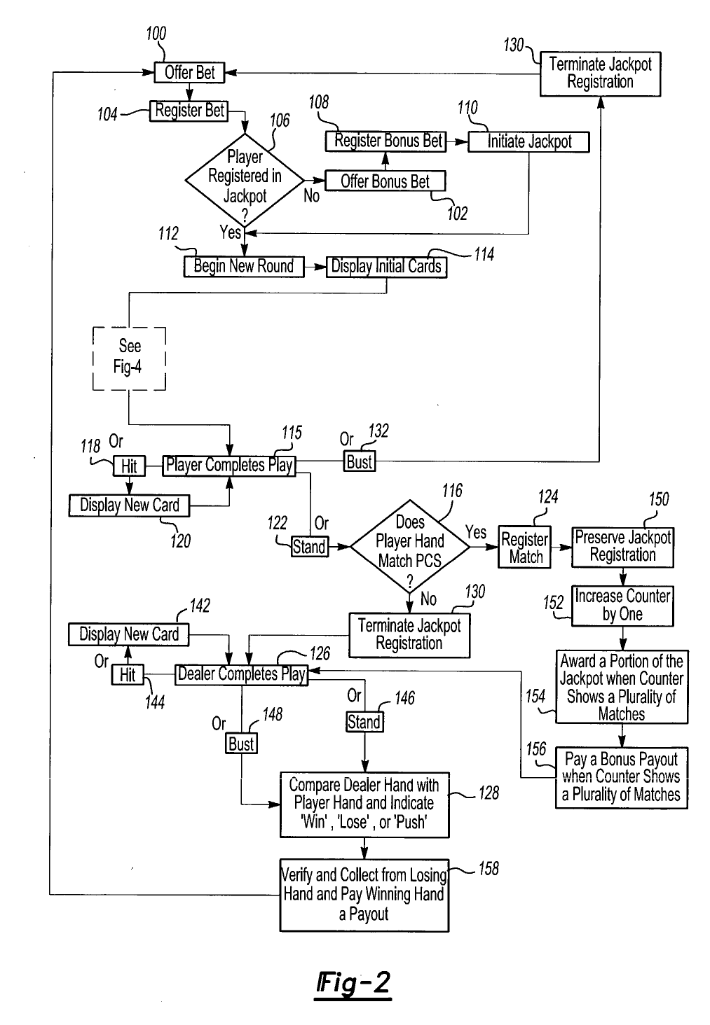

Referring also to FIGS. 2 & 3, the method of playing the computer blackjack game will now be described. To start, a player P preferably connects to the Internet via a modem or other linking device and accesses a web site in which the blackjack game is addressed. The web site is an interface between the player P and the CPU. The CPU represents a virtual casino for carrying out the blackjack game. It is to be understood that the term virtual casino is for illustrative purposes only and could comprise a single individual, a corporation, and the like. The virtual casino conducts the blackjack game in response to the player P registering with the virtual casino. Registration may include, recording critical information such as name, address, birth date, credit card information for betting purposes, and the like. This information is entered into fields on the web site and uploaded into the CPU of the virtual casino. The CPU is the heart of the virtual casino and performs many of the functions of the dealer in a traditional casino environment. Once uploaded, the player P is registered and is ready to begin playing the blackjack game. The web site will prompt the player P to begin play in the blackjack game and the screen 14 will appear as illustrated in FIG. 1 in response to the player P electing to play the blackjack game. The illustration in FIG. 1 is not intended to represent the identical screen 14 that will appear from the web site, but is intended to be a representation of some of the information and displays that may be shown.

Now that the player P is registered with the virtual casino and has accessed the blackjack game, the player P has the options of wagering a bet for blackjack play and wagering the bonus bet to be registered in the progressive jackpot. The player P must wager the bet to begin play in the blackjack game. However, the player P is not required to wager the bonus bet. Referring to FIG. 2, the virtual casino sets forth an offer for the bet 100 and an offer for a bonus bet 102 by way of the bet and the bonus bet indicia 38,20 located on the screen 14. In this embodiment, the bet and bonus bet indicia 38,20 are preferably buttons on the screen 14 that the player P activates using a peripheral computer device such as a mouse or light pen, or alternatively, the buttons may be activated using a touch screen. Preferably, the bet and the bonus bet are offered by the casino and wagered by the player P prior to the beginning of a round of play of the blackjack game.

The blackjack game is played in a plurality of similar rounds with similar steps being conducted in each round as will be described below. Therefore, the steps outlined below for a single round are replicated in subsequent rounds. Preferably, each round begins when the dealer begins dealing the cards to the player P and ends when the dealer either pays a winning hand or collects bets from a losing hand, as is well known in the art.

When the bet indicia 38 is activated by the player P, a signal is sent to the CPU via the bet register 16 indicating that the player P has wagered the bet for blackjack play. The bet register 16 senses the bet indicia 38 and indicates that the bet has been wagered and that play of the blackjack game can begin. Preferably, the bet is registered prior to each of the rounds to begin play in each of the rounds. Registering the bet 104 is an acknowledgement by the CPU that the player P wishes to participate in the round. The bet indicia 38 may indicate an amount of the bet or the player P may be prompted to enter the amount. The payment information registered in the CPU may be accessed to determine whether the player P has the funds to cover the bet. If the funds are adequate, the game continues. Otherwise, the player P may be prompted to enter additional payment information or to reduce the bet.

The progressive jackpot system 10 is activated when the player P wagers the bonus bet. The player P wagers the bonus bet by activating the bonus bet indicia 20. Specifically, when the bonus bet indicia 20 is activated, a signal is sent to the jackpot register 18, which is operatively connected with the jackpot processor 22, to then register the bonus bet 108. The jackpot register 18 senses the bonus bet indicia 20. The jackpot processor 22 communicates with the CPU and initiates the progressive jackpot 110 in response to registration of the bonus bet, thereby registering the player P in the progressive jackpot. Therefore, initiation of the progressive jackpot is in response to registering the bonus bet 108. As previously discussed, the jackpot register 18 may be a separate component of the progressive jackpot system 10, or may be integral with the jackpot processor 22 and simply represent a separate function of the jackpot processor 22. Additionally, the jackpot processor 22 may be a separate component of the progressive jackpot system 10, or may be integral with the CPU. In other words, the jackpot register 18 and jackpot processor 22 may be defined as the CPU adapted to register the bonus bet 108 and adapted to initiate the progressive jackpot 110 for the player P in response to the player P wagering the bonus bet.

As discussed above, the player P is not required to wager the bonus bet in order to begin play. However, if the player P wishes to participate in the progressive jackpot, the player P preferably wagers the bonus bet prior to one of the rounds. However, the player P can wager the bonus bet during the round. The results of the round in which the player P registers in the progressive jackpot during the round may or may not be accepted, depending on the point in time in which the player P registers with the progressive jackpot.

Preferably, the virtual casino offers the bonus bet 102, the player P wagers the bonus bet, and the jackpot register 18 registers the bonus bet 108 prior to at least one of the rounds to allow participation in the progressive jackpot. If the player P is already registered in the progressive jackpot prior to the beginning of the next round of play, the bonus bet is not offered to the player P. The jackpot processor 22 determines if the player P is registered in the jackpot 106. In the case of the computer embodiment, the bonus bet indicia 20 may be removed, or grayed out on the screen 14 such that the player P cannot activate the bonus bet indicia 20 if the player P is already registered in the progressive jackpot. In alternative embodiments, the bonus bet may be available even if the player P is already registered in the progressive jackpot, to increase an amount awarded in the progressive jackpot, or to increase chances to win the progressive jackpot.

A jackpot value of the progressive jackpot increases each time any player connected to the CPU wagers the bonus bet and the jackpot register 18 registers the bonus bet 108. A current jackpot value of the progressive jackpot is displayed on the jackpot display 24 while the game is played. Here, the jackpot display 24 is shown on the player's screen 14 while the game is played. As previously discussed, unit A and unit B of FIG. 1 represent two computer terminals networked to the CPU. As a result, when the player P of unit A wagers a bonus bet, the jackpot display 24 for both unit A and unit B increase by the bonus bet amount, thus demonstrating the progressive nature of the progressive jackpot. In the preferred embodiment, the progressive jackpot always begins at ten thousand dollars and the bonus bet is a set value of twenty-five cents. However, this is simply one example of the progressive jackpot. The progressive jackpot could be maintained and conducted in any number of ways. For example, a portion of the bonus bet could be added to the progressive jackpot, while the remaining portion is used to pay a nominal jackpot fee to the casino, or the like.

In the preferred embodiment, the CPU begins a new round 112 once the virtual casino has offered the bet 100 and bonus bet 102, the player P has wagered the bet and bonus bet, and the bet register 16 and jackpot register 22 have registered the bet 104 and bonus bet 108. Of course, as previously indicated, the blackjack game can be played without the player P wagering the bonus bet. To start the round, the CPU displays an initial plurality of cards 114 for the round. This is in response to registering the bet 104 in the round. In the computer embodiment of the blackjack game, the cards are representations of cards displayed on the player's computer screen 14. The cards are those used in playing blackjack, as are well known in the art. As will be appreciated by those skilled in the art, the cards have card values, i.e., numbered cards have a card value corresponding to their number, face cards have a card value of ten, and aces have a card value of either one or eleven. The cards are preferably selected at random by the CPU using a random number generator (not shown) that is responsive to the bet register 16.

Displaying the plurality of cards in the round is further defined as dealing the plurality of cards to the player P and dealing the plurality of cards to the dealer in response to registering the bet 104 for the round. Hence, the player P has a hand of cards shown in the player's cards presentation area 28 and the dealer has a hand of cards shown in the dealer's cards presentation area 29. Here, the dealer is a fictitious representation of the virtual casino and the dealer's cards are displayed onto the player's screen 14 along with the player's cards, as schematically illustrated in FIG. 1. After displaying the initial cards 114, the player P completes play 115 as will be appreciated by those skilled in the art. A description of blackjack play will not be provided, as conventional blackjack or twenty-one, as it is sometimes referred, is well known in the art.

During the round, the plurality of cards displayed or dealt to the player P in the round is compared to the predetermined card sequence (PCS) for that particular round to determine if the player's hand matches the PCS 116. The plurality of cards may include only the cards displayed in the initial deal, but preferably, the plurality of cards compared to the PCS also includes any cards the player P has taken as a hit 118 while completing play 115 during the round. For each hit taken 118, the CPU displays a new card 120 to the player P. If the plurality of cards that remain after the player P has decided to stand 122 or not take any more hits 118, matches the PCS, a match may be registered 124 for the player P in that round. A match is registered 124 in each of the plurality of rounds in response to the plurality of cards for the round matching the PCS for the round.

The player's hand is compared to the PCS prior to the dealer completing play 126 in the round. As a result, a match is registered 124 independent of the result of comparing the dealer's hand to the player's hand 128. The player's registration in the progressive jackpot, assuming the player P wagered the bonus bet, is terminated 130 if the player P busts 132 during the round, or if the plurality of cards dealt to the player P do not match the PCS. Once the determination of whether a match is registered 124 or registration is terminated 130, the dealer completes play 126. The dealer completes play 126 in much the same manner as the player P. Here, the CPU displays 142 a new card or effectively takes a hit 144 if the cards in the dealer's hand have a total card value of sixteen or less. Once the total card value of the cards in the dealer's hand reaches seventeen or more, the dealer stands 146 and no more cards are displayed, or alternatively, the dealer busts 148.

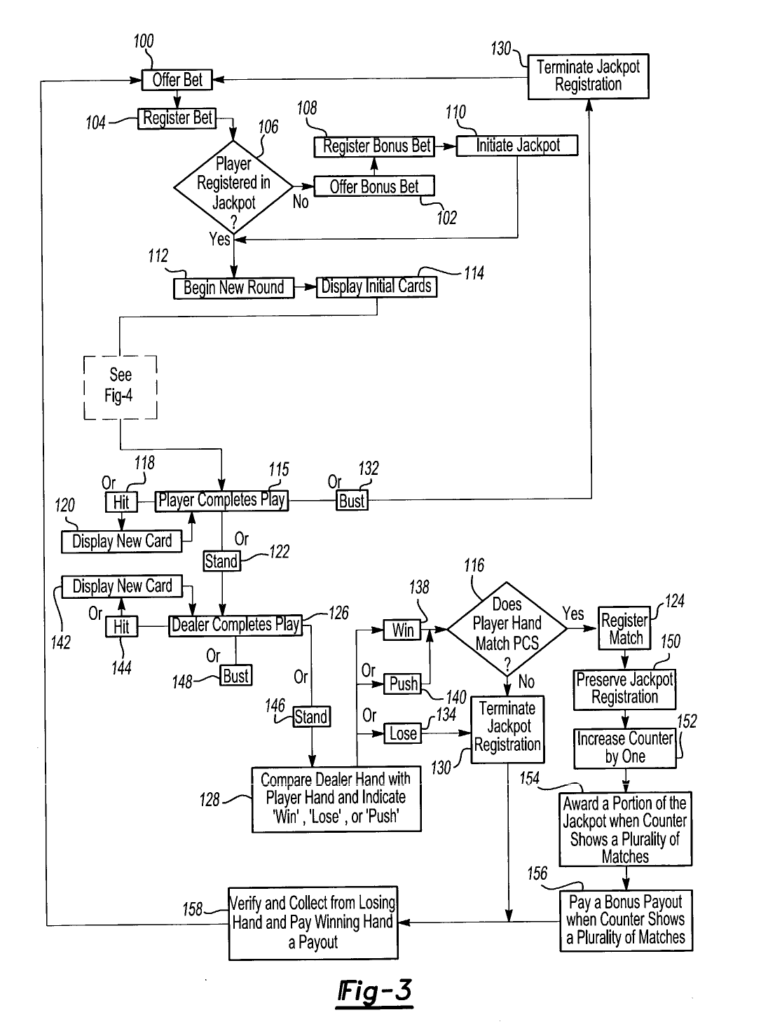

An alternative method of registering matches 124 is shown in FIG. 3. The comparison of the dealer's hand and the player's hand 128 is completed before comparing the player's hand to the PCS. In other words, the player P and the dealer both complete play 115,126 prior to determining whether a match should be registered 124. Furthermore, if the player's hand is a losing hand or cards, i.e., the player P busts or a loss is registered 134 for the player's hand, registration in the progressive jackpot is terminated 130. In other words, to register a match 124, the plurality of cards dealt to the player P must match the PCS, and the player P must have a winning hand of cards, i.e., register a win 138 against the dealer, or push 140. It is to be appreciated that the terms stand, hit, and push are well known to those skilled in the art.

Registration of the player P in the progressive jackpot is preserved 150 to the next round, i.e., between each of the rounds, if a match is registered 124 in a preceding round. Alternatively, if the player P busts in the round, such as when the plurality of cards has a total card value greater than twenty-one, or if the plurality of cards in the round does not match the PCS, then the player's registration in the progressive jackpot is terminated 130. When registration in the progressive jackpot is terminated, the virtual casino again offers the player P the bonus bet 102. The player P can wager the bonus bet to thereby re-register the player P with the progressive jackpot and re-initiate the progressive jackpot 110 for the player P.

Preferably, the PCS is the same for each of the plurality of rounds. However, the PCS may be different for each of the plurality of rounds. For instance, in the preferred embodiment, the PCS for each round is the player's hand having a total card value of twenty-one. The total card value is the additive card values of the plurality of cards in the player's hand. The PCS could also include, but is not limited to, the player's hand having a total card value of two, three, four, five, six, seven, eight, nine, ten, eleven, twelve, thirteen, fourteen, fifteen, sixteen, seventeen, eighteen, nineteen, twenty, twenty-one, blackjack, or any combination thereof.

The match register 26 is in operative communication with the jackpot processor 22 and registers the matches 124 of the player P when the plurality of cards in the player's hand matches the PCS in each of the plurality of rounds. The counter 30 is operative between the rounds and responsive to the match register 26 to count the matches of the player P registered by the match register 26. In addition, the memory 32 is operative between rounds to determine when the progressive jackpot is active or terminated for the player P. The memory 32 is in operative communication with the jackpot processor 22 and the counter 30 for resetting the counter 30 to zero when the progressive jackpot is terminated for the player P. Otherwise, the counter 30 is increased by one 152 for each match the player P has obtained while registered in the progressive jackpot.

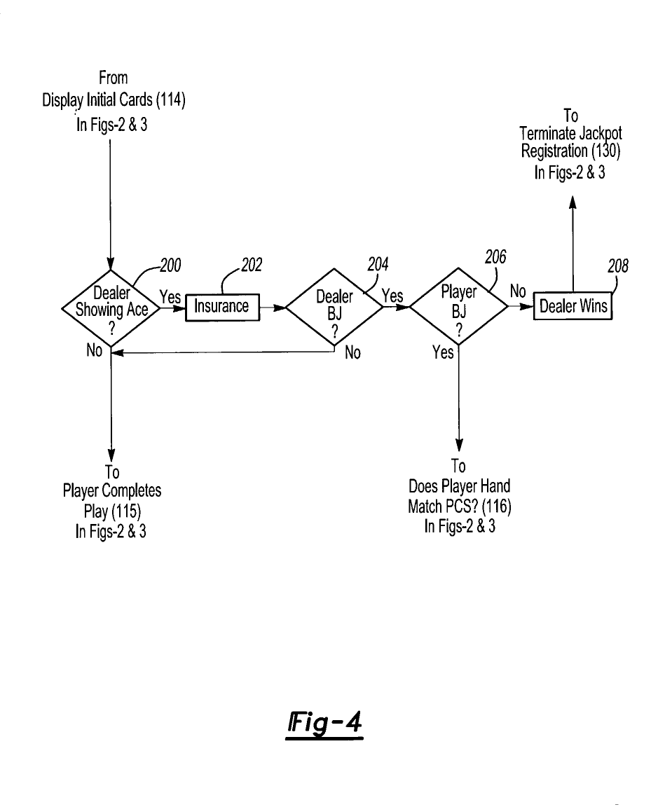

FIG. 4 shows how a dealer showing an ace after the initial cards have been displayed 114 can be managed by the present invention. After displaying the initial cards 114, if the dealer shows an ace 200, i.e., the dealer's hand has one card face down and one card face up that is an ace, then the following steps of the method may be carried out. First, the player P is offered insurance 202 for the bet, as is well known in the art. Next, the CPU determines 204 whether the dealer has a blackjack (BJ) 204, i.e., the dealer's hand has a total card value of twenty-one with only two cards. If the dealer does not have a blackjack, then the player P completes 115 play as shown in FIGS. 2 and 3. If the dealer does have a blackjack, then the CPU determines whether the player P has a blackjack (BJ) 206. If the player P does not, then the dealer wins 208 and registration in the progressive jackpot is terminated 130 for the player P. If the player P does have blackjack, then the plurality of cards in the player's hand is compared 116 to the PCS. If the plurality of cards matches the PCS, then a match is registered 124 and play continues as described in FIGS. 2 and 3. If they do not match, then registration in the progressive jackpot is terminated 130 for the player P and play continues as illustrated in FIGS. 2 and 3, by again offering the bet 100. It should be appreciated that if both the player P and the dealer have blackjack and this routine is employed, then the steps of FIG. 2 associated with the dealer completing play 126 are not performed after the player's hand is compared to the PCS.

It is to be understood that variations of the steps illustrated in FIG. 4 could be carried out. For instance, registration in the progressive jackpot could be preserved 150 even though the player's hand does not match the PCS, as long as the player P has blackjack, i.e., two cards with a total card value of twenty-one. Alternatively, registration in the progressive jackpot could be terminated 130 if the dealer has blackjack regardless of the cards in the player's hand.

At least a portion of the progressive jackpot is awarded 154 to the player P in response to the plurality of matches being registered 124 by the match register 26 in the plurality of rounds. In the preferred embodiment, the step of awarding at least a portion of the progressive jackpot 154 is further defined as awarding a predetermined percentage of the progressive jackpot in response to registering the plurality of matches 124 in the plurality of rounds. At least one of the matches is registered 124 in a first round and at least one of the matches is registered 124 in a second round different from the first round. Furthermore, in the preferred embodiment, the plurality of matches is registered 124 in consecutive rounds. However, this is not intended to limit the present invention. The matches may be registered in the plurality of rounds 124 with intervening rounds therebetween in which a match is not registered. For example, the steps used to play the game could be altered such that registration is preserved in the progressive jackpot 150 even if a match is not registered. Registration could be preserved in the progressive jackpot 150 if the player P has a winning hand, but the plurality of cards does not match the PCS for the round.

If the player P splits cards during play, as is well known in the art, more than one match may be registered 124 in a single round. However, the player P is awarded the portion of the progressive jackpot 154 only if at least one of the matches is registered 124 in one round and another one of the matches is registered 124 in a different round.

Preferably, the predetermined percentage of the progressive jackpot awarded increases as the total number of consecutive matches registered 124 increases, as dictated by a schedule of percentages. As an example, in the preferred embodiment, ten percent of the progressive jackpot is awarded 154 to the player P in response to registering matches 124 in each of three consecutive rounds, twenty-five percent of the progressive jackpot is awarded 154 to the player P in response to registering matches 124 in each of four consecutive rounds, and one-hundred percent of the progressive jackpot is awarded 154 to the player P in response to registering matches 124 in each of five consecutive rounds. Here the schedule of percentages is shown in Table 1:

TABLE 1

| Predetermined Card | Number of matches | Predetermined percentage |
|---|---|---|
| Sequence | registered | awarded |
| Twenty-One | Three | 10% |
| Twenty-One | Four | 25% |
| Twenty-One | Five | 100% |

The schedule of percentages dictating the progressive increase in the amount awarded is not intended to limit the present invention. For example, two matches in two rounds could result in anywhere from zero to one hundred percent of the progressive jackpot being awarded, or alternatively, one hundred percent of the progressive jackpot could be awarded in response to registering two consecutive matches. Additionally, in alternative embodiments, the player P can be awarded the value of the bet in response to registering a first match, commonly referred to as winning even money. Tables 2-5 below illustrate alternative schedules of percentages. These alternatives are not to be interpreted as limiting the present invention.

TABLE 2

| Predetermined Card | Number of matches | Predetermined percentage |
|---|---|---|
| Sequence | registered | awarded |
| Twenty-One | One | Even Money |
| Twenty-One | Two | 10% |
| Twenty-One | Three | 25% |
| Twenty-One | Four | 50% |
| Twenty-One | Five | 100% |

TABLE 3

| Predetermined Card | Number of matches | Predetermined percentage |
|---|---|---|
| Sequence | registered | awarded |
| Twenty-One | One | Even Money |
| Twenty-One | Two | 10% |
| Twenty-One | Three | 25% |
| Twenty-One | Four | 100% |

TABLE 4

| Predetermined Card | Number of matches | Predetermined percentage |
|---|---|---|
| Sequence | registered | awarded |
| Twenty-One | Two | 10% |
| Twenty-One | Three | 50% |
| Twenty-One | Four | 100% |

TABLE 5

| Predetermined Card | Number of matches | Predetermined percentage |
|---|---|---|
| Sequence | registered | awarded |
| Twenty-One | Two | 10% |
| Twenty-One | Three | 25% |
| Twenty-One | Four | 50% |
| Twenty-One | Five | 100% |

The step of awarding the predetermined percentage of the progressive jackpot includes paying the amount awarded 156 to the player P. An award generator 34 is in operative communication with the jackpot processor 22 and hence, the match register 26, counter 30, and memory 32, to determine the number of matches that have been registered for the player P. The award generator 34 computes the amount awarded to the player P based on the current jackpot value, the schedule of percentages, and the number of matches registered 124 by the match register 26. The number of matches registered 124 are counted by the counter 30. The jackpot generator 36 pays the amount awarded to the player P. However, as long as the player P remains registered in the progressive jackpot, i.e., the player's registration has not been terminated, the award is not paid to the player P. The award is not paid to the player P until registration is terminated 130. In this manner, additional matches can be registered 124 before the player P is paid even though the player P has already qualified for the award.

In alternative embodiments, if the award generator 34 has generated an award, then the amount of the progressive jackpot awarded by the award generator 34 is paid 156. If in a subsequent round an additional match is registered 124, such that the amount to be awarded based on the schedule of percentages increases, then the award generator 34 generates a new award by first subtracting the amount already paid 156 to the player P and the player P is paid the new award.

The jackpot generator 36 is responsive to the award generator 34 to pay the portion of the progressive jackpot awarded to the player P, i.e., the bonus payout. The bonus payout is based on the amount awarded, i.e., the predetermined percentage awarded based on the number of matches recorded in the plurality of rounds.

A determination of a payout or collection 158 based on the play of the blackjack game is also made as will be appreciated by one skilled in the art. This includes verifying and collecting from losing hands and paying a payout to winning hands. A payout generator 42 pays the player P in each round in response to registering the win in each round, as is well known in the art. Both the jackpot generator 36 and the payout generator 42 in the computer embodiment pay the player P by crediting an account with the virtual casino, transferring funds to a separate account of the player P, and/or mailing the funds to the player P.

An alternative embodiment of the present invention utilizing the video gaming format will now be described. The video gaming alternative is similar to the computer blackjack game described above in FIG. 1 for use in the online, Internet environment. Therefore, for descriptive purposes, only the differences between embodiments will be discussed.

To start, instead of connecting to the Internet via a modem or other linking device to access a web site, the player P accesses a video gaming terminal and connects to a local network connecting a plurality of video gaming terminals to the CPU. Connection may occur when the player P places the bet in a coin or bill acceptor and validator. The screen 14 will appear as illustrated in FIG. 1 in response to the player P wagering the bet to play the blackjack game. As previously discussed, the illustration in FIG. 1 is not intended to represent the identical screen 14 that will appear from the video gaming terminal, but is intended to be a representation of some of the information and displays that will be shown.

Now that the player P has accessed the blackjack game by wagering the bet for blackjack play, the player P has the option of wagering the bonus bet to be registered in the progressive jackpot. The bet and bonus bet indicia 38,20 for this embodiment may be located on the screen 14, but are preferably raised buttons (not shown) on a panel (not shown) adjacent to the screen 14. The player P activates the bet and bonus bet indicia 38,20 by pressing the buttons.

When the player P activates the bet indicia 38, a signal is sent to the bet register 16. In this embodiment, the bet register 16 may be a terminal processor of the video gaming terminal. The bet register 16 sends a corresponding signal to the CPU to indicate that the player P has wagered the bet for blackjack play. The bet register 16 indicates that the bet has been wagered and that play of the blackjack game can begin. Preferably, the bet is registered 104 prior to each of the rounds to begin play in each of the rounds. The bet and bonus bet wagered by the player P can come from an account card swiped in a card reader at the video gaming terminal, or coins or tokens placed in a coin/token acceptor and validator at the video gaming terminal.

A current jackpot value of the progressive jackpot is displayed on the video gaming terminal while the game is played. In this embodiment, unit A and unit B of FIG. 1 represent two video gaming terminals connected to the network and hence, are networked to the same CPU for implementing the blackjack game. As a result, when the player P of unit A wagers a bonus bet, the jackpot display 24 for both unit A and unit B increase by the bonus bet amount, hence, the progressive jackpot.

The round begins 112 once the casino has offered the bet and bonus bet 100,102, the player P has wagered the bet and bonus bet, and the bet register and jackpot register have registered 104,108 the bet and bonus bet. Of course, as previously indicated, the blackjack game can be played without the player P wagering the bonus bet. The CPU, or alternatively, the terminal processor, displays an initial plurality of cards 114 for the round. This is in response to registering the bet 104 for the round. In the video gaming embodiment of the blackjack game, the cards are representations of cards displayed on the player's video gaming terminal screen 14. The cards are those used in playing blackjack, as are well known in the art. The cards are selected at random by the terminal processor or CPU using the random number generator (not shown). The random number generator is responsive to the bet register 16.

The bonus payout and the payout in the video gaming embodiment are reflected by a payout of cash at the video gaming terminal or a payout in credit to an account used by the player P.

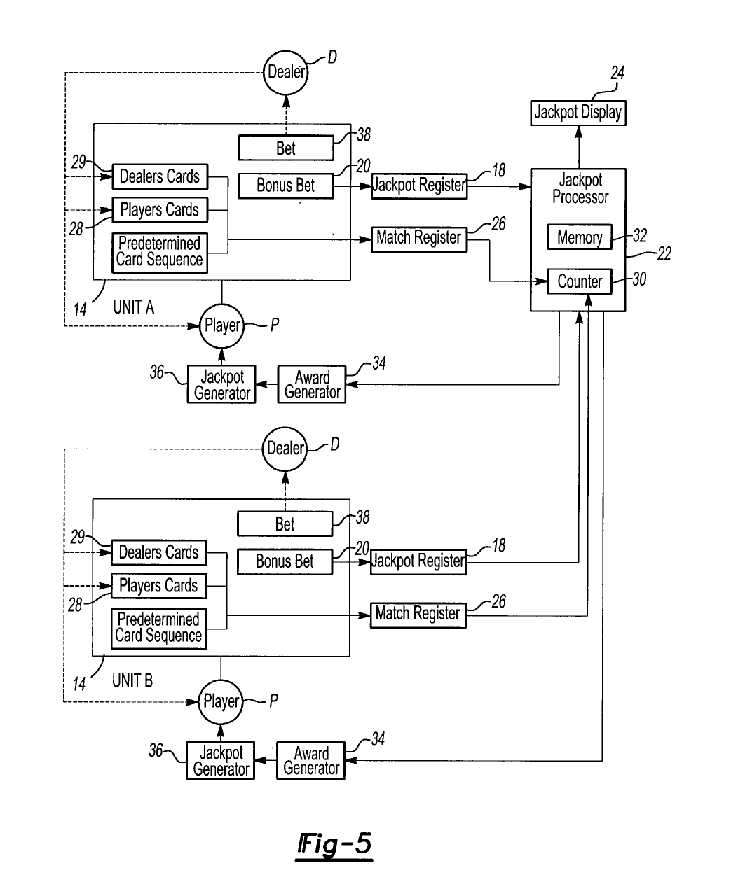

Referring to FIG. 5, another embodiment of the present invention utilizing the live-card game format will now be described. The live-card game format is similar to the computer and video gaming versions described above. Therefore, for descriptive purposes, only the differences between embodiments will be discussed.

To start, the player P does not connect to the Internet or to the network. The player P is seated at a live-card game table 14. Referring to FIG. 5, the table 14 is the equivalent of the screen 14 in the other embodiments and therefore, the same reference numeral is used. The casino offers the bet and the bonus bet 100,102 to the player P by way of the bet and bonus bet indicia 38,20 located on the table 14. The bet and bonus bet indicia 38,20 are preferably symbols or markers on the table 14 that the player P can use to wager the bet and the bonus bet. The bet and bonus bet can be in the form of cash, coins, tokens, account cards, and the like. Preferably, the player P uses the bet indicia 38 by placing a token or playing chip onto the bet indicia 38. The bonus bet indicia 20 could be a slot in the table 14 for placing the token or playing chip.

When the player P wagers the bet, the dealer D mentally registers the bet 104 and it is understood that the player P has wagered the bet for normal blackjack play. It is to be appreciated that the term registering as used herein does not necessarily require a signal to be sent to a central processing unit. Registering is an acknowledgement that the bet has been wagered and that the player P is eligible for play in the round. Referring to FIG. 5, the dealer D has taken the place of the CPU of FIG. 1, and performs many of the functions of the CPU in the other embodiments. Therefore, the dealer D registers the bets 104 wagered by the player P in each round.

When the player P wagers the bonus bet, the signal is sent to the jackpot register 18. The jackpot register 18 is operatively connected with the jackpot processor 22 to register the bonus bet 108. A plurality of players seated at a plurality of tables 14 could all be registered in the progressive jackpot if each of the players wagers the bonus bet. As such, the players are networked together in that the bonus bets wagered by any player P increase the jackpot value, as illustrated in FIG. 5 by the unit A and the unit B. The two units represent different players at different tables 14.

The dealer D could also take the place of the jackpot register 18 and jackpot processor 22. However, in normal circumstances, the tracking required for the progressive jackpot system 10 would be overwhelming to the dealer D. The jackpot register 18 could be a coin slot, token slot (similar to the bonus bet indicia 20), card reader, or bill acceptor that sends a signal to the jackpot processor 22. Alternatively, the jackpot register 18 could be a button corresponding to the player P that the dealer D presses when the player P has wagered the bonus bet. The jackpot processor 22 initiates the progressive jackpot 110 in response to registration of the bonus bet 108, thereby registering the player P in the progressive jackpot. The jackpot register 18 and jackpot processor 22 may be defined as the CPU adapted to register the bonus bet 108 and adapted to initiate the progressive jackpot 110 for the player P in response to the player P wagering the bonus bet.

A current jackpot value of the progressive jackpot is shown and continuously updated on a display suspended near the live-card game table 14 for viewing the current jackpot value while the game is played.

The round begins 112 once the casino has offered the bet and bonus bet 100,102, the player P has wagered the bet and bonus bet, and the dealer D and jackpot register have registered 104,108 the bet and bonus bet. Of course, as previously indicated, the blackjack game can be played without the player P wagering the bonus bet. Here, the dealer D displays or deals an initial plurality of cards 114 for the round. This is in response to registering the bet 104 for the round. The cards used can be from a single deck or multiple decks and are removed from a shoe of cards on the table 14 to be dealt to the player P and the dealer D, as is well known in the art. The cards are placed in the presentation areas 28,29 on the table 14 that can be sensed by the match register 26.

The match register 26 is in operative communication with the jackpot processor 22 and registers 124 the matches of the player P when the plurality of cards matches the PCS in each of the plurality of rounds. In the live-card game embodiment, the match register 26 may be automatically actuated using sensors that identify the cards dealt to the player P and the dealer D in the presentation areas 28,29. Alternatively, the dealer D may initiate the match register 26, such as by hitting a button to send a signal to the jackpot processor 22 that the cards in the player's hand match the PCS.

The dealer D can pay both the bonus payout and the payout 156,158 in the live-card game embodiment. Alternatively, the dealer D can pay the payout 158 while the bonus payout is paid 156 by the jackpot generator 36. In either event, a fund transfer is made in the player's favor.

The following is an example of playing the game in three rounds and is included for illustrative purposes. To start, a first bet is registered 104 to begin play in a first round of the game. A bonus bet separate from the first bet is registered 108 to allow participation in the progressive jackpot. The progressive jackpot is initiated 110 in response to registering the bonus bet. A first plurality of cards is displayed in the first round in response to registering the first bet and the bonus bet 104,108. The first plurality of cards is compared to a first PCS 116. A first match is registered 124 in response to the first plurality of cards matching the first PCS. Registration in the progressive jackpot is preserved 150 in response to registering 124 the first match.

A second bet is registered 104 to begin play in a second round of the game consecutive with the first round. A second plurality of cards is displayed in the second round in response to registering the second bet. The second plurality of cards is compared to a second PCS 116. A second match is registered 124 in response to the second plurality of cards matching the second PCS. Registration is preserved in the progressive jackpot 150 in response to registering the second match 124.

A third bet is registered 104 to begin play in a third round of the game consecutive with the second round. A third plurality of cards is displayed in the third round in response to registering the third bet. The third plurality of cards is compared to a third PCS 116. A third match is registered 124 in response to the third plurality of cards matching the third PCS.

Comparing the plurality of cards in each of the first, second, and third rounds 116 is further defined as determining whether each of the first, second, and third plurality of cards have a total card value of twenty-one, i.e., twenty-one is the PCS.

At least a portion of the progressive jackpot is awarded 154 in response to registering the first, second, and third matches 124 in consecutive first, second, and third rounds. The step of awarding at least a portion of the progressive jackpot 154 is further defined as awarding a predetermined percentage of the progressive jackpot in response to registering the first, second, and third matches in the consecutive first, second, and third rounds.

Obviously, many modifications and variations of the present invention are possible in light of the above teachings. The invention may be practiced otherwise than as specifically described within the scope of the appended claims.

What is claimed is:

1. A method of playing a game in a plurality of rounds and incorporating a progressive jackpot into the game, said method comprising the steps of:
registering a bet for each of the rounds to play in each of the rounds;
registering a bonus bet separate from the bet to allow participation in the progressive jackpot;
initiating the progressive jackpot in response to registering the bonus bet;
displaying a plurality of cards in each of the rounds in response to registering the bet for each of the rounds;
comparing the plurality of cards in each of the rounds to a predetermined card sequence for each of the rounds;
registering a match in each of the rounds in response to the plurality of cards matching the predetermined card sequence for each of the rounds;
preserving registration in the progressive jackpot between each of the rounds; and
awarding at least a portion of the progressive jackpot in response to registering a plurality of matches in the plurality of rounds.

2. The method as set forth in claim 1 wherein the step of awarding at least a portion of the progressive jackpot is further defined as awarding a predetermined percentage of the progressive jackpot in response to registering a plurality of matches in a plurality of consecutive rounds.

3. The method as set forth in claim 2 further including the step of increasing the predetermined percentage of the progressive jackpot awarded as the number of consecutive matches increase.

4. The method as set forth in claim 3 further including the step of terminating registration in the progressive jackpot in response to the plurality of cards in one of the plurality of rounds differing from the predetermined card sequence for that round.

5. The method as set forth in claim 2 further including the step of paying a bonus payout based on the predetermined percentage awarded.

6. The method as set forth in claim 1 wherein the step of displaying the plurality of cards in each of the rounds is further defined as dealing the plurality of cards to a player in response to registering the bet for each of the rounds.

7. The method as set forth in claim 6 further including the step of dealing a plurality of cards to a dealer in response to registering the bet for each of the rounds.

8. The method as set forth in claim 7 further including the step of registering a win to the player when the plurality of cards dealt to the player is a winning hand of cards.

9. The method as set forth in claim 8 wherein the step of registering a match is further defined as registering a match in each of the rounds in response to the plurality of cards dealt to the player matching the predetermined card sequence and the player having the winning hand of cards.

10. The method as set forth in claim 7 further including the step of terminating registration in the progressive jackpot when the plurality of cards dealt to the player is a losing hand of cards.

11. The method as set forth in claim 8 further including the step of paying a payout in each round in response to registering the win in each round.

12. The method as set forth in claim 1 further including the step of increasing a jackpot value of the progressive jackpot in response to registering the bonus bet.

13. The method as set forth in claim 1 further including the step of displaying a jackpot value of the progressive jackpot while the game is played.

14. The method as set forth in claim 2 wherein playing the game in the plurality of rounds is further defined as playing blackjack in a plurality of rounds and the predetermined card sequence for each round is a player having a total card value of twenty-one in each round.

15. The method as set forth in claim 14 wherein playing blackjack in the plurality of rounds is further defined as playing blackjack in three consecutive rounds.

16. The method as set forth in claim 15 wherein the step of awarding the predetermined percentage of the progressive jackpot is further defined as awarding ten percent of the progressive jackpot in response to registering matches in each of the three consecutive rounds.

17. The method as set forth in claim 14 wherein playing blackjack in the plurality of rounds is further defined as playing blackjack in four consecutive rounds.

18. The method as set forth in claim 17 wherein the step of awarding the predetermined percentage of the progressive jackpot is further defined as awarding twenty-five percent of the progressive jackpot in response to registering matches in each of the four consecutive rounds.

19. The method as set forth in claim 14 wherein playing blackjack in the plurality of rounds is further defined as playing blackjack in five consecutive rounds.

20. The method as set forth in claim 19 wherein the step of awarding the predetermined percentage of the progressive jackpot is further defined as awarding one-hundred percent of the progressive jackpot in response to registering matches in each of the five consecutive rounds.

21. The method as set forth in claim 1 wherein the step of awarding at least a portion of the progressive jackpot is further defined as awarding a predetermined percentage of the progressive jackpot in response to registering a plurality of matches in a plurality of rounds wherein at least one of the matches occurs in a first round and at least one of the matches occurs in a second round different from the first round.

22. A method of playing a blackjack game in a plurality of rounds and incorporating a progressive jackpot into the blackjack game, said method comprising the steps of:
registering a first bet to begin play in a first round of the game;
registering a bonus bet separate from the first bet to allow participation in the progressive jackpot;
initiating the progressive jackpot in response to registering the bonus bet;
displaying a first plurality of cards in the first round in response to registering the first bet and the bonus bet;
comparing the first plurality of cards to a first predetermined card sequence;
registering a first match in response to the first plurality of cards matching the first predetermined card sequence;
preserving registration in the progressive jackpot in response to registering the first match;
registering a second bet to begin play in a second round of the game consecutive with the first round;
displaying a second plurality of cards in the second round in response to registering the second bet;
comparing the second plurality of cards to a second predetermined card sequence;
registering a second match in response to the second plurality of cards matching the second predetermined card sequence;
preserving registration in the progressive jackpot in response to registering the second match;
registering a third bet to begin play in a third round of the game consecutive with the second round;
displaying a third plurality of cards in the third round in response to registering the third bet;
comparing the third plurality of cards to a third predetermined card sequence;
registering a third match in response to the third plurality of cards matching the third predetermined card sequence; and
awarding at least a portion of the progressive jackpot in response to registering the first, second, and third match in consecutive first, second, and third rounds.

23. The method as set forth in claim 22 wherein the step of awarding at least a portion of the progressive jackpot is further defined as awarding a predetermined percentage of the progressive jackpot in response to registering the first, second, and third matches in the consecutive first, second, and third rounds.

24. The method as set forth in claim 23 further including the step of paying a bonus payout based on the predetermined percentage.

25. The method as set forth in claim 24 further including the step of increasing a jackpot value of the progressive jackpot in response to registering the bonus bet.

26. The method as set forth in claim 25 further including the step of terminating registration in the progressive jackpot in response to the plurality of cards in one of the plurality of rounds differing from one of the predetermined card sequences.

27. The method as set forth in claim 22 wherein the steps of comparing the first, second, and third plurality of cards to the first, second, and third predetermined card sequences is further defined as determining whether each of the first, second, and third plurality of cards have a total card value of twenty-one.

28. The method as set forth in claim 22 further including the step of displaying a jackpot value of the progressive jackpot while the game is played.

29. A progressive jackpot system for use in a game played by a player in a plurality of rounds in which the player wagers a bet for each of the plurality of rounds to display a plurality of cards and the player initiates a progressive jackpot by wagering a bonus bet in addition to wagering the bet, said system comprising:
a jackpot register for registering the bonus bet and initiating the progressive jackpot in response to the bonus bet being wagered by the player;
a jackpot processor responsive to said jackpot register for controlling the progressive jackpot;
a match register in operative communication with said jackpot processor for registering matches of the player when the plurality of cards matches a predetermined card sequence in each of the plurality of rounds; and
a counter operative between rounds and responsive to said match register for counting matches of the player registered by said match register.

30. The system as set forth in claim 29 further including a memory operative between rounds for determining when the progressive jackpot is terminated for the player, said memory in operative communication with said jackpot processor and said counter for resetting said counter to zero when the progressive jackpot is terminated for the player.

31. The system as set forth in claim 30 further including an award generator for awarding at least a portion of the progressive jackpot to the player in response to said counter counting a plurality of consecutive matches.

32. The system as set forth in claim 31 further including a jackpot generator responsive to said award generator for paying the portion of the progressive jackpot awarded to the player.

33. The system as set forth in claim 32 further including a presentation area sensed by said match register for displaying the plurality of cards in each of the plurality of rounds.

34. The system as set forth in claim 33 further including a bet indicia sensed by said bet register for offering the bets in each of the rounds to the player.

35. The system as set forth in claim 34 further including a bonus bet indicia sensed by said bonus bet register for offering the bonus bet to the player.

36. The system as set forth in claim 35 further including a bet register for registering each of the bets in response to the bets being wagered by the player for each of the plurality of rounds.

37. The system as set forth in claim 36 further including a jackpot display in operative communication with said jackpot processor for displaying a jackpot value of the progressive jackpot.
